(19) United States
(12) Patent Application Publication
(10) Pub. No.: US 2005/0126063 A1
(43) Pub. Date: Jun. 16, 2005

(54) Fishing rods storage system

(76) Inventor: Rickie A. Bowerman, Naples, FL (US)

Correspondence Address: Rickie A. Bowerman, 4170 3rd Ave SW, Naples, FL, 34119, US

(21) Appl. No.: 10/733,967

(22) Filed: Dec. 12, 2003

(51) Int. Cl. A01K 97/10

(52) U.S. Cl. 43/21.2

(57) ABSTRACT

A fishing pole retention system on a boat that includes at least two retention blocks that are spaced from each other on an installation on a boat having bores therein that will receive ends of fishing poles. Each of the retention blocks can arrest or clamp therein an end of the fishing poles. The clamping mechanism involves a screw activated clamping block that moves up or down or involves a sliding mechanism that moves at least two clamping blocks in a sideways movement. Both clamping mechanisms are easily moved to and arrested position or to an open position.

### CROSS REFERENCE TO RELATED APPLICATIONS (NONE)

### STATEMENT REGARDING FED SPONSORED R & D (NONE)

### BACKGROUND OF THE INVENTION

The invention involves the storage of fishing rods and reels, especially on a boat recreational boats as well as professional fishing boats including deep sea fishing boats carry a certain number of fishing rods so that any number of persons can participate in the sport of fishing. As is well known, fishing rods are quite oblong, they are flexible, have bulky reels attached thereto and most often have fishing lines dangling from one end to another. If these fishing rods are not properly secured, especially when not in use, they can be a quite a nuisance. Moreover, a fishing boat is not a steady vessel and is in a constant motion which adds to the difficulty of maintaining everything secure and tidy aboard ship.

### SUMMARY OF THE INVENTION

Because of the above, the invention involves a simple construction by which all of the fishing rods on board the ship or boat can easily be stored and secured and out of the way of the people onboard but still be will easily available for instant use if so desired. The construction involves the use of at least two spaced apart blocks that are mounted in an out of the way position. The blocks have several bores therein of a certain diameter and when a fishing rod is placed at their ends, one end into each bore, the fishing rods are out of the way. Each bore in each of the blocks has a locking mechanism therein so that the fishing rod is securely fastened therein.

### BRIEF DESCRIPTION OF THE DRAWINGS

FIG. 1 is a perspective view three fishing rods being secured under the canopy of a boat;

FIG. 2 is a perspective view of how the fishing rods are placed in the blocks and fastened therein

FIG. 3 illustrates one type of a locking mechanism;

FIG. 4 is an exploded view of a different type of locking mechanism;

FIG. 5 shows the locking mechanism of FIG. 4 in an assembled condition.

### DETAILED DESCRIPTION OF THE INVENTION

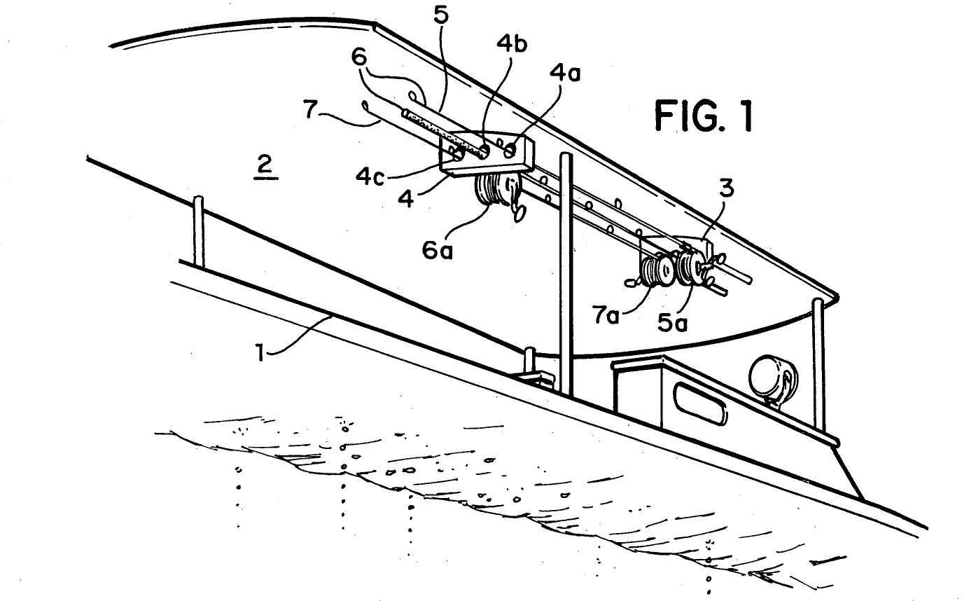

FIG. 1 shows three 5, 6 and 7 fishing rods installed in an out of the way location under the canopy 2 of a boat 1. It is obvious that any additional numbers of fishing rods can be installed in this manner. For example, any number of fishing rods could be installed along the gunwale of a boat, as long as a certain straight length is available. The storage system consists of at least two blocks 3 and 4. Each of the storage blocks has at least three bores 4a, 4b and 4c in block 4 to accommodate at least three fishing rods. It is important that the fishing rods placed are placed into the blocks in an alternating fashion because of the presence of the reels 5a, 6a and 7a which prevent the rods from being closely spaced to each other because of their bulk. This way, the reels are alternating in their position.

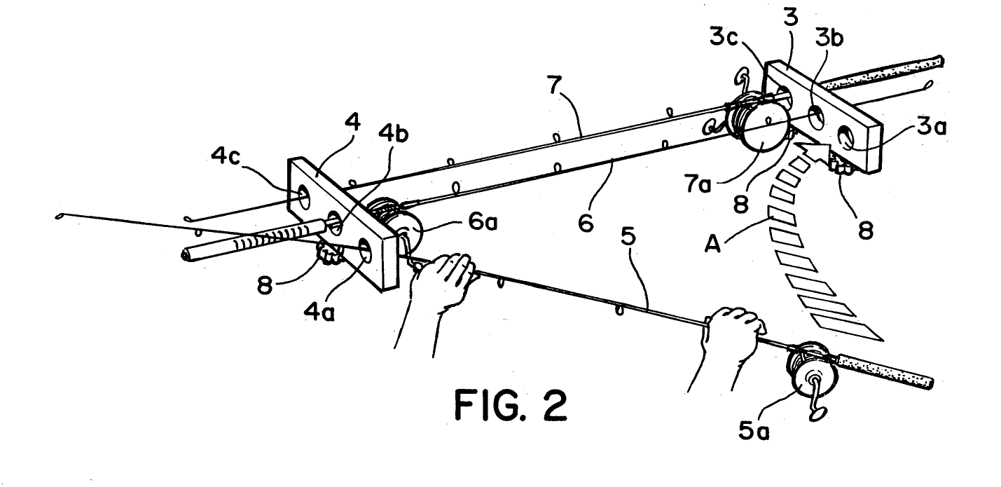

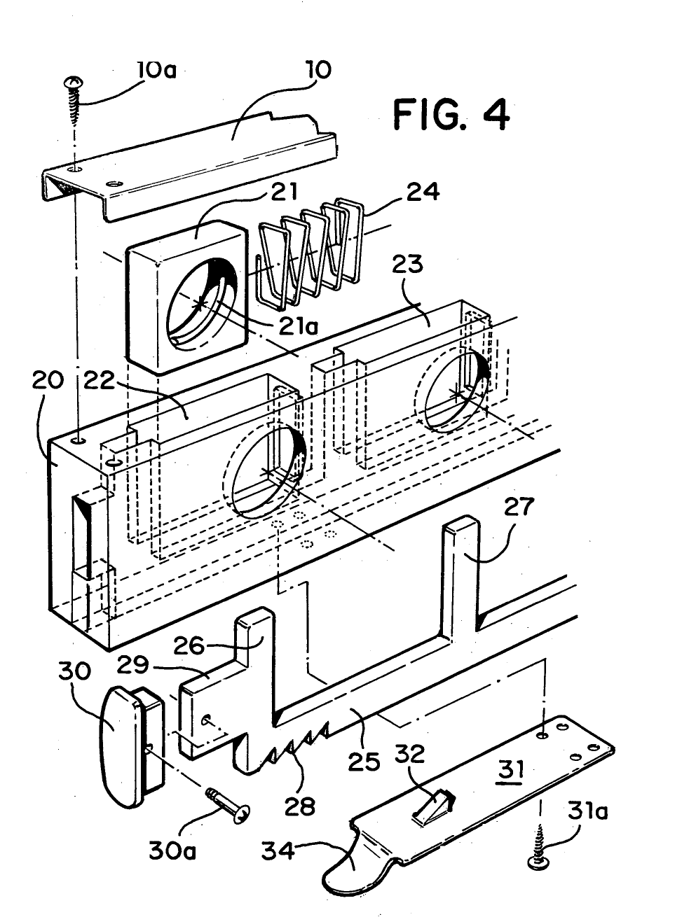

FIG. 2 shows the alternating positions of the fishing rods more clearly. FIG. 4 also shows the clamping devices for clamping the fishing rods in a secure location. To this end, there are shown the knurled knobs 8 which will arrest the rods 5, 6, and 7 securely in place when turned. The arrow A illustrates the movement of one of the finishing rods 5, for example, in it proper sequence of installation. FIG. 2 shows the same reference characters as were used in explaining the details of FIG. 1.

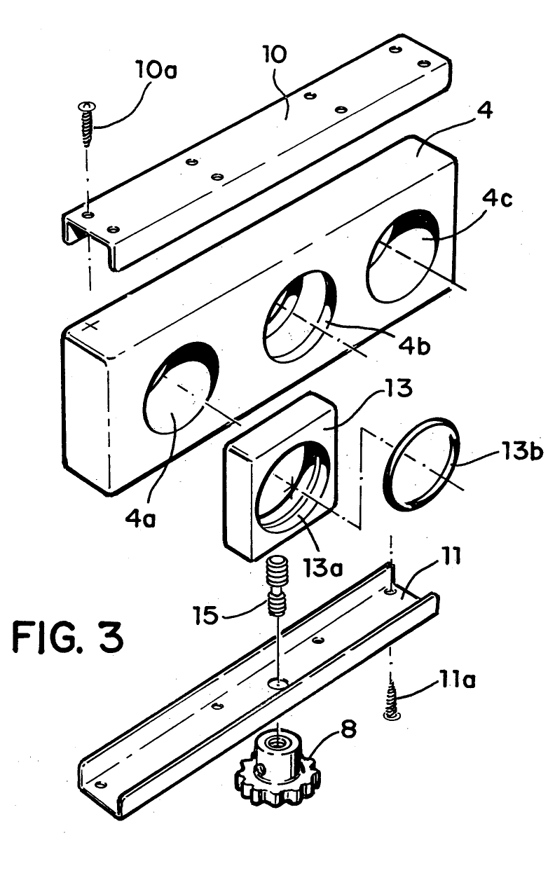

FIG. 3 shows the details of the clamping mechanism. This FIG. 3 shows the details of the storage block 4 with its attending reference characters. This block can accommodate only one clamped fishing rod and therefore, shows only clamping block 13 to be used in the middle of the storage block 4. It should be made clear at this point that the two outside bores 4a and 4c can also accommodate each a fishing rod instead of the middle one 4b as shown in FIG. 3, as long as any two fishing rods are separated from each other so that any two reels do not interfere with each other. To reinforce the clamping block at its top and bottom edges, an edge molding 10 (top) and 11 (bottom) is used by way of screws 10a 11a, respectively. The storage block 4 has a recess therein to receive the clamping block 13 in a sliding manner. The clamping block 13 has the opening 13a there through. The opening 13a is the same size as the bores 4a, 4b and 4c to receive the handle of the fishing rod therein. The opening 13a has an O-ring 13b on its interior for the protection of the handle of the fishing rod. The clamping block 13 is moved up or down by way of knurled knob 8 which has a double headed screw end one of which is fastened into the knurled knob 8 while the other end is screwed into the clamping block 13. Thereby, any turning of the knurled knob 8 will move the clamping block 13 in any direction and if so desired will move the clamping block 13 either up or down to clamp the handle of the fishing rod into a clamping positions.

FIG. 4 is an explosive view of a different clamping device. The same reference characters are being used as were shown in previous FIGS. In the previous embodiment, the clamping blocks were moved up and down while in this embodiment they are moving sideways to arrive at the same results and that is to clamp the fishing rods in a sideways movement In this embodiment the retention block 20 has elongated slots or reception recesses 22 and 23 therein in which each will receive a clamping block 21 (only one is shown). The clamping block 21 is of the same dimension as that of FIG. 3. The clamping block 21 also has an O-ring 21a therein as was explained with reference to the clamping block 13 and 13b in FIG. 3. This embodiment also has an activating slide 25 mounted within the retention block 20. The activating slide 25 has upstanding activating spars 26 and 27 thereon which reach into the recess 22 and 23, respectively, of the retention block 20. The activating slide 25 has a lateral extension 29 thereon for the purpose of receiving a pad 30 thereon which is fastened thereon by way of a screw 30a. There is also a compression spring 24 located between the clamping slides 22 and 23. In a bottom recess, there is also located an arresting plate 31 having an arresting dog 32 thereon. Once all the above described elements are installed, the compression spring 24 will push the clamping block 21 to the left in FIG. 4 against the activating spar 26 while the activating spar 27 pushes against the activating spar 27. The activating slide 25 has ratchet teeth on a bottom side thereof which will engage the arresting dog 32 on the bottom arresting plate 31.

### Operation

When the fishing rods are to be installed, the activating slide 25 will be pushed to the right in FIG. 4 against the bias of the spring 24 and by way of the clamping block 21. At this point, the activating slide 25 will be arrested in the biased position by way of the arresting teeth being blocked against the arresting dog 32. Once all the fishing rods are installed, it merely takes a pull down on the arresting plate 31 at the release latch 34 to liberate the ratchet teeth from the arresting dog 32 to free the activating slide from its arrested status and move the clamping plate 21 and the other clamping block on the right of FIG. 4 (not shown) to a clamping position because of the bias of the spring 24. If it desired to free the arrested fishing rods from their present position, it is merely a matter of pushing the activating slide 25 by way the pad 30 to free the activating spars 26 and 27 from pushing the clamping blocks 21 from clamping the fishing rods.

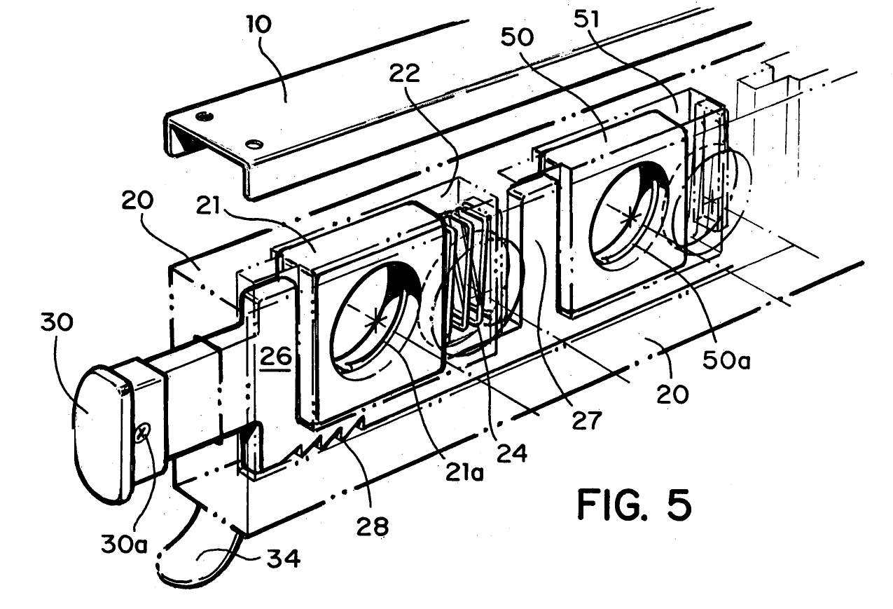

FIG. 5 shows the exploded view of FIG. 4 in an assembled state. The same reference characters are shown as was in previous FIGS. This retention system of fishing rods illustrates a system for arresting two fishing rods in one system. In this system, there are two the clamping blocks 21 and 50 alluded to with regard to FIG. 4 and the second recess 51 as a reception for the clamping block 50.

1. A multiple fishing rods retention system of fishing rods comprising at least two retention blocks spaced from each other, each of said retention blocks having bores there through for receiving ends of said fishing rods, each of said bores having a means for clamping a fishing rod disposed therein.

2. The fishing rod retention system of claim 1, wherein said means for clamping includes a clamping block, said clamping block is movable relative to each of said retention blocks to obstruct said bore to trap said fishing rod therein.

3. The fishing rod retention system of claim 2, wherein said clamping block moves in an up and down manner.

4. The fishing rod retention system of claim 1, wherein said clamping block moves in a side to side manner.

5. The fishing rod retention system of claim 4, wherein there are at least two clamping blocks.

6. The fishing rod retention system of claim 5, wherein each of said clamping blocks is spring biased into a clamping position.

7. The fishing rod retention system of claim 6 including means for arresting said clamping blocks into a non-clamping position.

8. The fishing rod retention system of clam 7, wherein said non-clamping position is released by a single latch release.
